(19) United States
(12) Patent Application Publication
(10) Pub. No.: US 2004/0178277 A1
(43) Pub. Date: Sep. 16, 2004

(54) Automatic package process for a card and package for a small card

(76) Inventor: Hank Wang, Hsinchu City (TW)

Correspondence Address: Morton J. Rosenberg, Rosenberg, Klein & Lee, 3458 Ellicott Center Drive, Suite 101, Ellicott City, MD, 21043, US

(21) Appl. No.: 10/657,122

(22) Filed: Sep. 9, 2003

(30) Foreign Application Priority Data
Mar. 14, 2003 (TW) 092204023,0921057

(51) Int. Cl. G06F 7/08; G06K 19/06

(52) U.S. Cl. 235/492

(57) ABSTRACT

An automatic package process for a card comprises stamping a metal belt to form two shells without leaving from the metal belt, injection molding two plastic frames onto the metal shells, respectively, and combining the plastic frames together to form a case. A package for a small card comprises two metal shells each having a thickness not larger than 0.15 mm, several stakes thereon and an inner surface coated with an insulator film thereon, and two plastic frames having a thickness not larger than 0.7 and 1.4 mm, respectively, injection molded onto the metal shells and embedding the stakes thereon, wherein the plastic frames are combined together by a glue or sonic welding.

### FIELD OF THE INVENTION

The present invention relates generally to a card type package method and structure and, more particularly to an automatic package process for a card and package for a small card.

### BACKGROUND OF THE INVENTION

Electronic devices are developing into compact, light, mobile and digital, and thus makes card type apparatus more common, especially memory cards are widely used in various mobile apparatus, such as MP3 Walkmans, personal digital assistant (PDA), digital cameras and cellular phones. In order to reduce the size of the card, the standard goes from early PCMCIA to flash memory card and even smaller cards.

Small cards have different specifications, most common are CF (Compact Flash) card, MMC (Multi-Media Card), SD (Secure Digital) card, SM (Smart Media) card, MS (Memory Stick) card, among which CF cards have 37 mm in length, 43 mm in width and 3.3 mm in thickness, MMC cards have 32 mm in length, 24 mm in width and 1.4 mm in thickness, SD cards have 32 mm in length, 24 mm in width and 2.1 mm in thickness, SM cards have 45 mm in length, 37 mm in width and 0.76 mm in thickness, and MS cards have 21.5 mm in length, 50 mm in width and 2.8 mm in thickness. For PCMCIA cards have large scale, metal shell body can be used without insulating problems. But in small cards package, the thickness of the cards are extremely small, the insulation between the package shell and internal circuit have to be overcome. Conventional small cards use plastic injection molded shells to achieve the purpose of insulation.

The package for conventional small cards can be generally divided into two categories, one of them is the adhesive package which includes two plastic shells glued into one box, but the adhesion package often peels or brakes, and the internal components are damaged easily. Besides, the process requires huge manpower with low productivity, thus using adhesion package requires higher cost with lower yield. Another one is the injection molded package method, by which the plastic card body is directly injected onto the printed circuit board (PCB) to embed the printed circuit board. Since injection molding technique is used, there's drawback as peeling of the shell. But the high temperature process during injection molding may easily damage the printed circuit board or the component thereon, twisting may happen easily as well. The plastic package has its inherent disadvantages. A PCMCIA card is thick and can obtain enough mechanical thickness with a metal shell, but small card has thin plastic shell, and thus is lack of mechanical strength, easily broke and damaged.

On the other hand, the advanced package method for a PCMCIA card is to inject the plastic frame directly to form on the metal shell, and then weld the plastic frames of the upper and lower shells together, referring to for example Taiwanese pat. no. 122,733, U.K. pat. no. 2,295,118, Japanese pat. no. 2,686,051 and U.S. Pat. No. 5,475,919 all issued to the Assignee of the present applicant. The manufacturing process using injection molding and sonic welding can reduce manpower cost with higher yield. However, it's still time-consuming to put the metal shell into the mold one by one during injection molding process, and is hard to achieve automation for such work. And for small cards with plastic shell, microinjection molding technique is required with higher cost and lower yield, and can't be automation either.

Accordingly, it is desired an automatic package process for card type apparatus and improved package for small cards that can be automatically manufactured with metal shell body.

### SUMMARY OF THE INVENTION

One object of the present invention is to provide an automatic package method for a card with simple process, short working time, low cost, high reliability and is good for mass production.

Another object of the present invention is to provide a small card package process, which can package a small card with higher strength and reliability more easily and cheaply.

Still another object of the present invention is to provide a small card package to increase the mechanical strength, decrease damage, and the package is good for automatic production.

In an automatic package process for a card, according to the present invention, there included stamping a metal belt to form metal shells, injection molding plastic frames on each metal shell to form half cases. After the metal half cases are removed from the metal belt, sonic welding is used to weld two plastic frames to form a card package.

According to the present invention, a package for a small card with thickness no more than 3.3 mm comprises two metal shells with stake with thickness no more than 0.15 mm. The inner surfaces of the metal shells are coated with an insulator film. Two plastic frames are injected molded respectively and directly attached to two metal shells and embed the stakes to form two half cases. The thickness of top and bottom plastic frames are not larger than 0.7 and 1.4 mm, respectively, and the top and bottom plastic frames are sonic welded together to form the card package.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 is the stereographic diagram of a small card according to the present invention;

FIG. 2 is the stereographic diagram viewing from the inner surface of the upper metal shell of FIG. 1;

FIG. 3 is the stereographic diagram viewing from the upper half case of FIG. 1;

FIG. 4 is the stereographic diagram viewing from the lower surface of the upper metal shell of FIG. 1;

FIG. 5 is the stereographic diagram viewing from the lower half case of FIG. 1;

FIG. 6 is the top view of FIG. 1;

FIG. 7 is the cross-sectional diagram of A-A′ in FIG. 6;

FIG. 8 is the cross-sectional diagram of B-B′ in FIG. 6;

FIG. 9 is the flow chart of an automatic package process according to the present invention;

FIG. 10 shows stamping to a metal belt to form the upper metal shell;

FIG. 11 shows stamping to the upper metal shell to form a stake;

FIG. 12 shows injection molding to form plastic frame on the upper metal shell;

FIG. 13 shows printing of pattern on the insulator film of the upper metal shell; and

FIG. 14 is a schematic diagram of the upper metal shell removed from the metal belt.

### DETAILED DESCRIPTION OF THE INVENTION

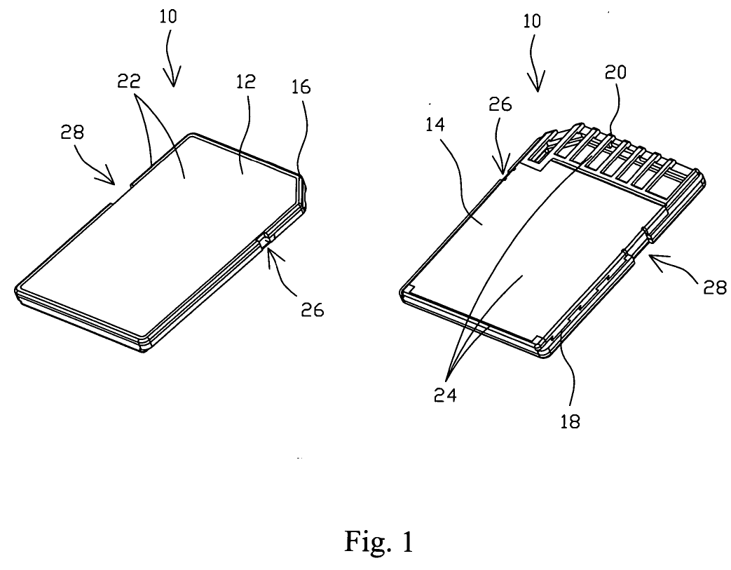

FIG. 1 is the stereographic diagram of a small card according to the present invention. A small memory card 10 includes an upper and lower metal shell 12 and 14, preferably made of a stainless steel sheet, among which the upper metal shell 12 is combined with a plastic frame 16 to form an upper half case 22, and the lower metal shell 14 is combined with another plastic frame 18 to form a lower half case 24. The lower plastic frame 18 has an I/O (input/output) portion 20. The upper and lower plastic frames 16 and 18 matches to each other and are sonic welded together. Two recesses 26 and 28 extend from the outer surfaces of the upper and lower plastic frames 16 and 18 to the upper and lower metal shells 12 and 14 on opposite sides of the small memory card 10, respectively. Since the package of the small card 10 uses metal shell instead of plastic shell, the recesses 26 and 28 can be further used for grounding to prevent electromagnetic interference (EMI), as a PCMCIA card does.

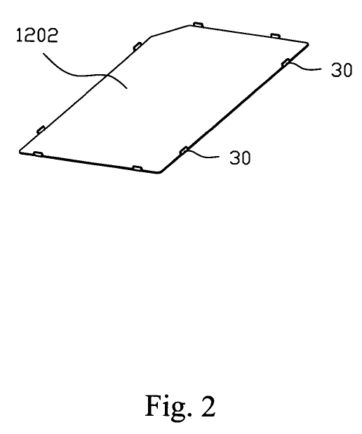

FIG. 2 is a stereographic diagram viewing from the inner surface 1202 of the upper metal shell 12 of FIG. 1. The upper metal shell 12 has several stakes 30 to enhance injection molding applied directly on the upper metal shell 12 to form plastic frame 16 by enclosing the stakes 30. The inner surface 1202 of the upper metal shell 12 is coated with an insulator film, preferably a Teflon. A conventional small memory card has thickness no more than 3.3 mm and thus causes insulation issues, and plastic shell is therefore used for insulation purpose. The present invention uses metal shell and coats its inner surface with insulator film, and as a result, the problems for insulation and mechanical strength can be solved simultaneously.

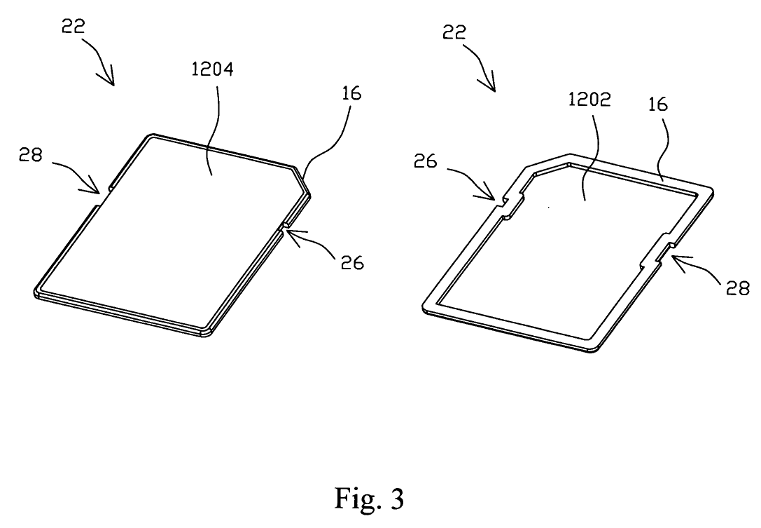

FIG. 3 is a stereographic diagram viewing from the upper half case 22 of FIG. 1. The inner surface 1202 of the upper metal shell 12 is coated with an insulator film, and the plastic frame 16 embeds the stakes 30.

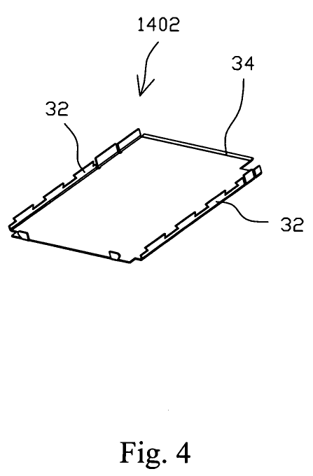

FIG. 4 is a stereographic diagram viewing from the inner surface 1402 of the lower metal shell 14 of FIG. 1. The lower metal shell 14 has several stakes 32 and a bent extension 24, and the surface 1402 is covered with an insulator film for insulation, preferably a Teflon.

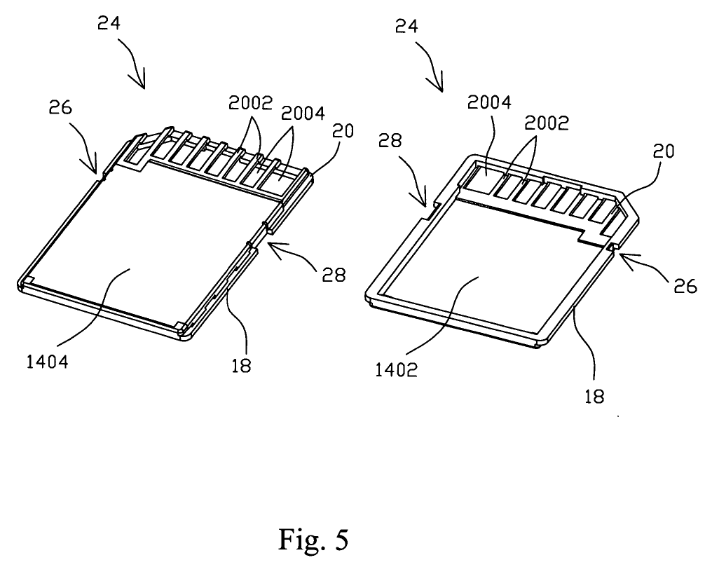

FIG. 5 is a stereographic diagram viewing from the lower half case 24 of FIG. 1. The inner surface 1402 of the lower metal shell 14 is coated with an insulator film. The plastic frame 18 has I/O portion 20, and injection molding technique is used to embed the bent extension 24 into the I/O portion 20, with the plastic frame 18 embedding the stake 28. I/O portion 20 has a plastic frame 2002 and holes 2004 to expose the copper of the transmission ports of the printer circuit board inside the small memory card 10.

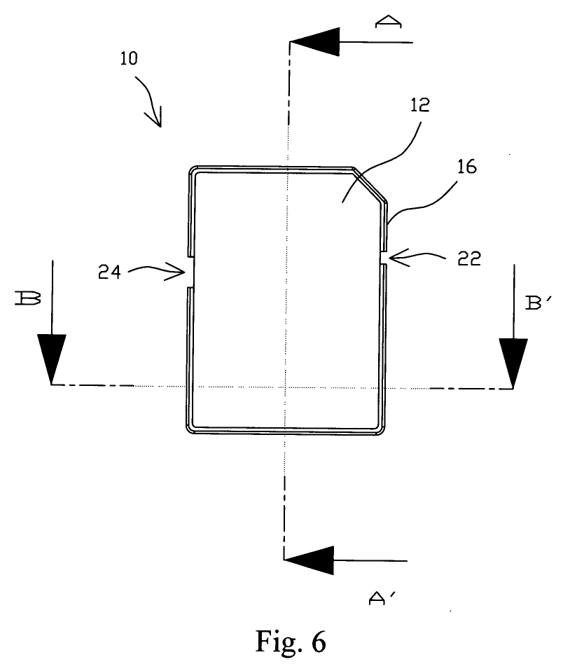

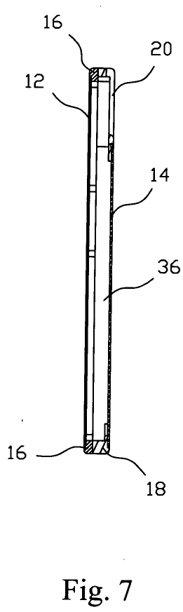

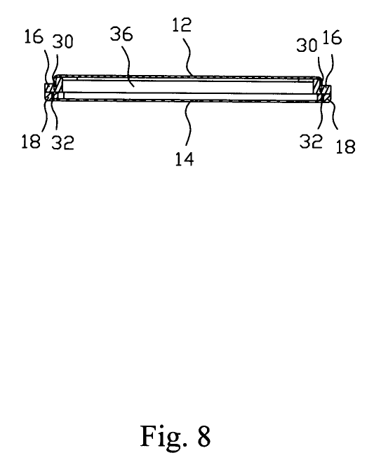

FIG. 6 is the top view of FIG. 1. The peripheral of the upper metal shell 12 of the small memory card 10 is surrounded with the upper plastic frame 16. FIG. 7 is the A-A′ cross-sectional view of FIG. 6. The upper and lower metal shells 12 and 14 can be different in structure. The upper metal shell 12 and upper plastic frame 16 are combined to form an upper half case 22, and the lower metal shell 14 and lower plastic frame 18 are combined to form a lower half case 24. The lower plastic frame 18 has the I/O portion 20. The upper and lower plastic frames 16 and 18 are sonic welded to combine the upper and lower half cases 22 and 24 to form a case. The space 36 is for printed circuit board to be placed therein and on the I/O portion 20 is exposed the copper of the transmission port on the printed circuit board. FIG. 8 is the B-B′ cross-sectional view of FIG. 6. The upper metal shell 12 has several stakes 30, and the upper plastic frame 16 embeds the stakes 30. The upper metal shell 12 is combined with the upper plastic frame 16 to form the upper half case 22. The lower metal shell 14 also has several stakes 32 and is injection molded with the lower plastic frame 18 to embed the stakes 32. The lower metal shell 14 is combined with the lower plastic frame 18 to form a lower half case 24. The upper and lower half cases 22 and 24 can have different thickness, wherein the thickness of the upper metal shell 12 is 0.15 mm, and the lower metal shell 14 has a thickness of 0.15 mm. The upper plastic frame 16 has a thickness of 0.7 mm, and the thickness of the lower plastic frame 18 is 1.4 mm.

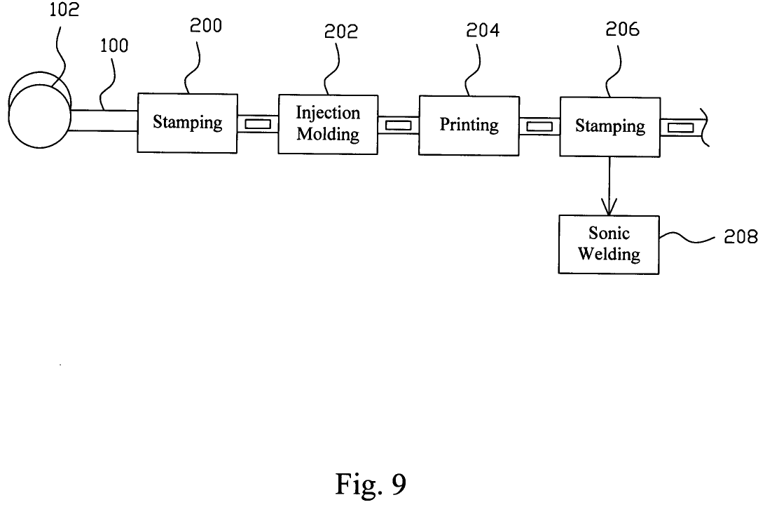

FIG. 9 is the flow chart of an automatic package process according to the present invention. A metal belt 100 is pulled out from a roll 102 with a thickness less than 0.15 mm. In step 200, the metal belt 100 is stamped to form the metal shells 12 and 14. In step 202, the metal shells 12 and 14 are injection molded to form the plastic frames 16 and 18 thereon. In step 204, the metal shells 12 and 14 are printed with patterns on their inner surfaces. Step 206 is stamping to remove the half cases 22 and 24, by which the metal shells 12 and 14 are stamped to leave the metal belt 100. The last step 208 is sonic welding the plastic frames 16 and 18 on the metal shells 12 and 14 to form a case 10.

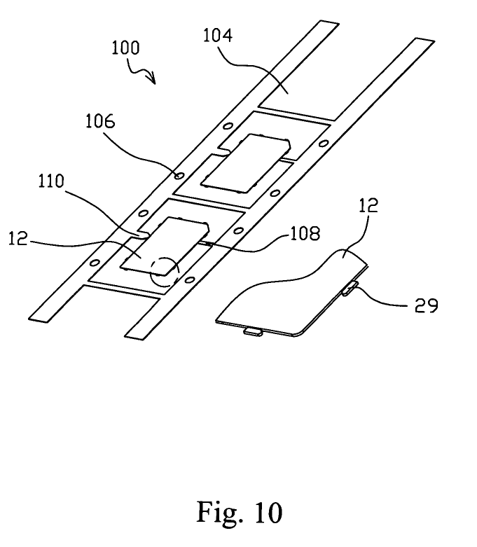

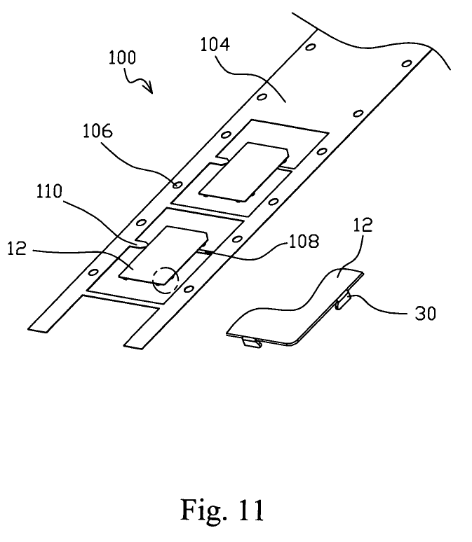

FIG. 10 is a schematic diagram for the step 200, by which the metal belt 100 is stamped to form the upper metal shell 12. The metal belt 100 uses a stainless steel for example, to pre-coated with an insulator film 104 such as Teflon on the inner surface, and has periodic holes 106 on its both sides for a transfer apparatus to bring it to move on a production line. The stamped metal shell 12 has several strips 29 and is still connected to the metal belt 100 with connection bars 108 and 110 on its both sides such that it won't leave the metal belt 100. The strips 29 of the metal sheet 12 are bent also by stamping to form the stakes 30, as shown in FIG. 11.

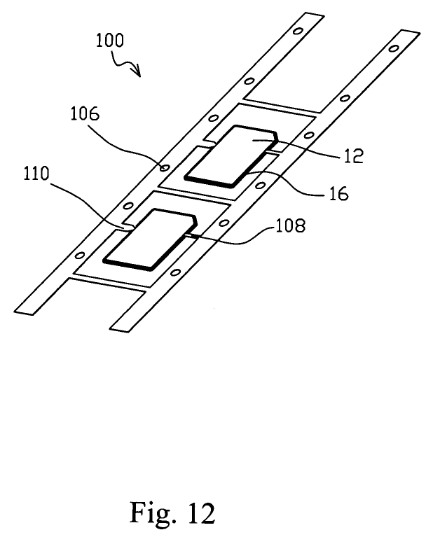

In FIG. 12, injection molding is applied on the metal shell 12 to directly form the plastic frame 16 to embed the stake 30 to tightly bound these two pieces together to form a half case 22. The cooling time of the injection molded plastic frame 16 is within 3 seconds.

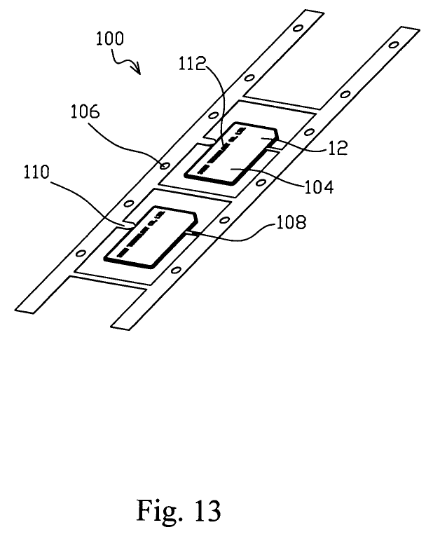

FIG. 13 is to print a pattern 112 on the insulator film 104 of the metal shell 12, and this step is optional, mainly for printing trademarks or other labels for identifications.

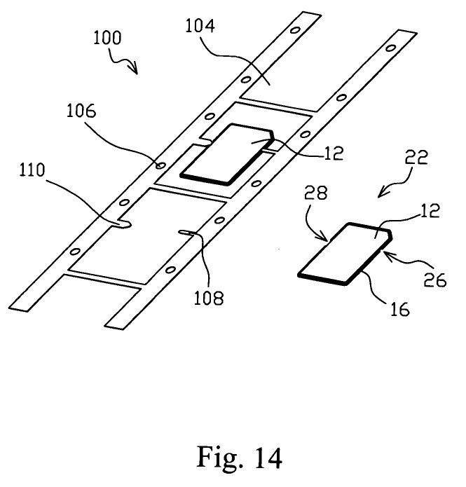

FIG. 14 is to cut the connection bars 34 and 36 between the metal shell 12 and metal belt 100 by stamping to release the upper half case 22 from the metal belt 100 and at the same time to form the recesses 26 and 28. This step is to unload the semi-finished products. The lower half-case 24 is formed by the same process as in the aforementioned description. In the last step 208 is sonic welding the upper and lower half cases 22 and 24 together to form the small memory card 10.

In this process, both upper and lower half cases are directly manufactured on the metal belt, and the metal belt is capable of transferring on automatic equipments. Thus, this process can reach the goal of fast and cheap production.

The aforementioned embodiment process can be modified, for example releasing the card body from the metal belt after the sonic welding or printing patterns before stamping for the shells.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

What is claim d is:

1. An automatic package process for a card, comprising the steps of:
transferring a metal belt;
stamping said metal belt to form a first and second metal shells without releasing from said metal belt;
injection molding a first and second plastic frames on said first and second metal shells, respectively; and
combining said first and second plastic frames to form a case.

2. A process of claim 1, further comprising printing patterns on said first and second metal shells after forming said first and second plastic frames.

3. A process of claim 1, wherein said stamping for first and second metal shells comprises forming a plurality of strips on opposite sides of said metal shells.

4. A process of claim 3, further comprising bending said strips for forming stakes.

5. A process of claim 1, further comprising stamping said first metal shell for forming a bent extension.

6. A process of claim 4, wherein said first and second plastic frames embed said stakes on said first and second metal shells, respectively.

7. A process of claim 5, wherein said second plastic frame embeds said bent extension of said second metal shell.

8. A process of claim 1, wherein said first and second plastic frames are combined together by sonic welding.

9. A process of claim 1, wherein said metal belt is coated with an insulator film thereon.

10. A process of claim 1, further comprising removing said first and second metal shells from said metal belt after injection molding said first and second plastic frames.

11. A package for a small card with a thickness not larger than 3.3 mm, said package comprising:
first and second metal shells each having a thickness not larger than 0.15 mm, a plurality of stakes and an inner surface coated with an insulator film; and
first and second plastic frames embedding said plurality of stakes, respectively, to form first and second half cases, said first plastic frame having a thickness not larger than 0.7 mm, said second plastic frame having a thickness not larger than 1.4 mm;
wherein said first and second plastic frames are combined together to form a case.

12. A package of claim 11, wherein said first and second plastic frames have a recess.

13. A package of claim 11, wherein said second plastic frame has an I/O portion on which said second metal shell has a bent extension embedded therewith.

14. A package of claim 11, wherein said first and second plastic frames are combined by a glue.

15. A package of claim 11, wherein said first and second plastic frames are combined by a sonic welding.

16. A package of claim 11, wherein said insulator film comprises a Teflon.
